(19) United States
(12) Patent Application Publication
(10) Pub. No.: US 2016/0041447 A1
(43) Pub. Date: Feb. 11, 2016

(54) METHOD AND APPARATUS FOR DRIVING AN ELECTROCHROMIC ELEMENT

(71) Applicant: CANON KABUSHIKI KAISHA, Tokyo (JP)

(72) Inventors: Jun Yamamoto, Tokyo (JP); Kenji Yamada, Yokohama-shi (JP); Shinjiro Okada, Kamakura-shi (JP)

(21) Appl. No.: 14/810,755

(22) Filed: Jul. 28, 2015

(30) Foreign Application Priority Data
Aug. 5, 2014 (JP) 2014-159412

(51) Int. Cl. G02F 1/163; H04N 5/335; G02F 1/155

(52) U.S. Cl. CPC G02F 1/163; G02F 1/155; H04N 5/335; G02F 2001/1502

(57) ABSTRACT

Provided is an apparatus for driving an electrochromic element having an excellent operating performance, which is capable of controlling, during a transitional state in which a light transmittance changes, a speed and period of the transitional state, the apparatus for driving an electrochromic element being configured to perform, when an absorbance of an electrochromic element is to be increased from a current absorbance to a target absorbance, before normal drive of driving the electrochromic element at a duty ratio (D1) for maintaining the target absorbance, accelerated drive of driving the electrochromic element at a duty ratio (D2) larger than the duty ratio (D1).

### BACKGROUND OF THE INVENTION

1. Field of the Invention

The present invention relates to a method and apparatus for driving an electrochromic element.

2. Description of the Related Art

An electrochromic (EC) phenomenon is a phenomenon in which a material is colored or decolored through changes in its light absorption region induced by a reversible electrochemical reaction (oxidation reaction or reduction reaction) caused at the time of application of a voltage. An electrochemically coloring/decoloring element utilizing the EC phenomenon is referred to as “electrochromic (EC) element,” and is expected to find applications as a light control element configured to change a light transmittance. As the EC element, there have been known an inorganic EC element using a metal oxide such as WO₃, and an organic EC element using an organic low-molecular compound such as a viologen and an electroconductive polymer. Of those elements, it has been known that the organic EC element, in which a low-molecular organic material is colored/decolored in a solution state, has advantages of a sufficient contrast ratio in a colored state, a high transmittance in a decolored state. In addition, it has been known that the organic EC element has an advantage in that its color state can be arbitrarily controlled by mixing a plurality of materials having different absorption wavelengths.

In order to use such an EC element in an optical filter, there is required a drive method for controlling the light transmittance arbitrarily. Further, it is also required to prevent a significant change in wavelength selectivity (absorption spectrum) of light absorption in the element even at the time of a change in light transmittance.

As the drive method for controlling the light transmittance, in Japanese Patent Application Laid-Open No. H11-109423, there is disclosed a pulse width modulation (PWM) drive method involving applying, to an inorganic EC element, a voltage for causing an electrochemical reaction as a pulse and controlling a ratio of a duration of voltage application to one cycle of the pulse (duty ratio).

Further, in “Solar Energy Materials & Solar Cells” 104, (2012), pp. 140 to 145, there is such a disclosure that an organic EC element formed of a single type of material is operated through PWM drive. The ratio of the duration of voltage application for causing the electrochemical reaction to one cycle of the pulse (duty ratio) is controlled in the same manner as in Japanese Patent Application Laid-Open No. H11-109423. Further, there is also such a disclosure that during a remaining duration of the one cycle of the pulse, the voltage application is paused and the element is put into an open circuit state.

Still further, in Japanese Patent Application Laid-Open No. 2002-122843, there is disclosed a drive method for a light control element using liquid crystal, in which a high voltage is applied to the light control element prior to normal drive so as to accelerate the operation of the liquid crystal element.

In order to control the light transmittance of the EC element, the PWM drive for adjusting the duration (duty ratio) of voltage application for causing the electrochemical reaction can be used. However, there has been the following problem in a process of changing a magnitude of the light transmittance. Specifically, the light transmittance depends on the duty ratio, and hence in order to change the light transmittance, a set value of the duty ratio needs to be changed. The light transmittance changes toward a value corresponding to the set duty ratio while passing through a transitional state, and is then saturated and maintained at this value. At this time, when a length of time spent during the transitional state is long, operating performance of the EC element deteriorates, and hence the transitional characteristics need to be improved.

In Japanese Patent Application Laid-Open No. H11-109423 and in “Solar Energy Materials & Solar Cells” 104, (2012), pp. 140 to 145, no consideration is given to improvement of the transitional characteristics in which the light transmittance changes, and those disclosures of the related art have been insufficient for the enhancement of the operating performance of the EC element.

Further, a method of applying a voltage higher than a normal voltage during the transitional state to accelerate the element operation, such as the drive of the liquid crystal element disclosed in Japanese Patent Application Laid-Open No. 2002-122843, has not been necessarily preferred for the EC element. For example, in an organic EC element containing a plurality of types of materials, due to a difference in oxidation-reduction potential or molar absorption coefficient among the materials, the absorption spectrum changes in some cases relative to a voltage. Therefore, there has been required a drive method that is particularly preferred for the organic EC element.

### SUMMARY OF THE INVENTION

The present invention has been made in view of the above-mentioned background art, and has an object to provide a method and apparatus for driving an electrochromic element having an excellent operating performance, which are capable of controlling, during a transitional state in which a light transmittance changes, a speed and period of the transitional state.

According to one embodiment of the present invention, there is provided an apparatus for driving an electrochromic element, the apparatus being configured to apply a continuous drive pulse to an electrochromic element, the electrochromic element including an electrochromic layer that contains an electrochromic material and is sandwiched between a pair of electrodes, and to change an absorbance of the electrochromic element with use of a duty ratio of the continuous drive pulse,

the continuous drive pulse having one cycle including an applied period of a drive voltage and a stopped period of the drive voltage,

the drive voltage being a voltage for causing at least one of an oxidation reaction of the electrochromic material and a reduction reaction of the electrochromic material, the stopped period being a period in which, in a closed circuit including the electrochromic element, a resistor having a resistance value larger than a resistance value of another resistor to be connected during the applied period is connected in series,

the duty ratio being a ratio of the applied period of the drive voltage to the one cycle,

the apparatus being configured to perform, when the absorbance of the electrochromic element is to be increased from a current absorbance to a target absorbance, before normal drive of driving the electrochromic element at a duty ratio D1 for maintaining the target absorbance, accelerated drive of driving the electrochromic element at a duty ratio D2 larger than the duty ratio D1.

Further, according to one embodiment of the present invention, there is provided a method of driving an electrochromic element, for applying a continuous drive pulse to an electrochromic element, the electrochromic element including an electrochromic layer that contains an electrochromic material and is sandwiched between a pair of electrodes, and changing an absorbance of the electrochromic element with use of a duty ratio of the continuous drive pulse,

the continuous drive pulse having one cycle including an applied period of a drive voltage and a stopped period of the drive voltage,

the drive voltage being a voltage for causing at least one of an oxidation reaction of the electrochromic material and a reduction reaction of the electrochromic material,

the stopped period being a period in which, in a closed circuit including the electrochromic element, a resistor having a resistance value larger than a resistance value of another resistor to be connected during the applied period is connected in series,

the duty ratio being a ratio of the applied period of the drive voltage to the one cycle,

the method including performing, when the absorbance of the electrochromic element is to be increased from a current absorbance to a target absorbance, before normal drive of driving the electrochromic element at a duty ratio D1 for maintaining the target absorbance, accelerated drive of driving the electrochromic element at a duty ratio D2 larger than the duty ratio D1.

Further features of the present invention will become apparent from the following description of exemplary embodiments with reference to the attached drawings.

### BRIEF DESCRIPTION OF THE DRAWINGS

FIG. 1 is a schematic diagram for illustrating an example of an EC apparatus using a drive apparatus according to the present invention.

FIG. 2 is a schematic cross-sectional view for illustrating an example of an EC element to be used in the present invention.

FIG. 3 is a diagram for illustrating a voltage application method according to the present invention.

FIG. 4 is a diagram for illustrating one drive control mode of a drive method according to the present invention.

FIG. 5 is a diagram for illustrating an example of an image pickup apparatus according to the present invention.

FIG. 6 is a diagram for illustrating another example of the image pickup apparatus according to the present invention.

FIG. 7A and FIG. 7B are views each for illustrating an example of a window member according to the present invention.

FIG. 8 is a graph for showing a change in absorbance obtained when an EC element according to Example of the present invention was driven from a decolored state at a fixed duty ratio in a coloring direction.

FIG. 9 is a graph for showing a change with time in absorbance of the EC element according to Example 1 obtained when accelerated drive was used.

FIG. 10A, FIG. 10B, and FIG. 10C are graphs each for showing an absorption spectrum of an EC element according to Example 2 of the present invention.

FIG. 11 is a graph for showing a relationship between a change in absorbance and drive time of an EC element according to Example 3 of the present invention.

FIG. 12 is a graph for showing a change in absorbance of an EC element according to Example 4 of the present invention in a decoloring direction.

FIG. 13A, FIG. 13B, FIG. 13C, and FIG. 13D are graphs each for showing a change with time in absorbance of an EC element according to Example 5 of the present invention at the time of coloring and decoloring.

### DESCRIPTION OF THE EMBODIMENTS

Now, the present invention is described in detail.

<<Method and Apparatus for Driving EC Element>>

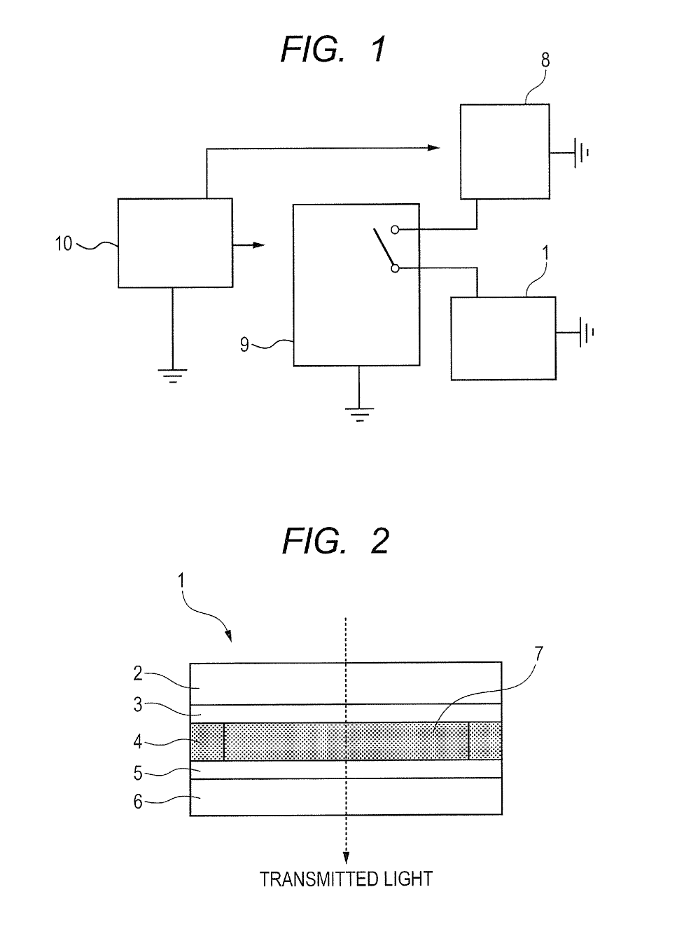

FIG. 1 is a schematic diagram for illustrating an example of an EC apparatus using a drive apparatus of the present invention. The EC apparatus of FIG. 1 includes an EC element 1 in which an EC layer containing an EC material is sandwiched between a pair of electrodes, and a drive apparatus configured to drive the EC element 1 (a drive power supply 8, a resistor switch 9, and a controller 10).

(EC Element)

FIG. 2 is a schematic cross-sectional view for illustrating an example of an EC element to be used in the present invention. The EC element of FIG. 2 has a configuration in which transparent substrates 2 and 6 having formed thereon transparent electrodes 3 and 5, respectively are bonded to each other through a spacer 4 so that electrode 3 and 5 sides face each other, and an EC layer 7 in which an electrolyte and an organic EC material are dissolved in a solvent is present in a space formed by the pair of electrodes 3 and 5 and the spacer 4. The organic EC material causes an electrochemical reaction when a voltage is applied between the electrodes 3 and 5. Note that, the present invention is preferably applied to an organic EC element, but may be applied to an inorganic EC element using an inorganic EC material.

In general, the organic EC material is in a neutral state under a state in which a voltage is not applied, and does not show absorption in a visible light region. In such decolored state, the organic EC element exhibits a high light transmittance. When a voltage is applied between the electrodes, the organic EC material causes an electrochemical reaction to be converted from the neutral state to an oxidized state (cation) or a reduced state (anion). The organic EC material shows absorption in the visible light region in the form of cation or anion, to be colored. In such colored state, the organic EC element exhibits a low light transmittance. In addition, there also exists a material that forms a transparent dication structure in an initial state and is colored in blue through one-electron reduction, like a viologen, which is a typical organic EC material.

In the following discussion, the light transmittance of the EC element is replaced with the absorbance of the EC element. The transmittance and the absorbance have a relationship of −log (transmittance)=(absorbance). Every time the transmittance is reduced to ½, the absorbance is increased by about 0.3.

<Substrates 2 and 6>

In the case of using the EC element as a light control element, it is preferred that the EC element keep a high transmittance in a decolored state in order to reduce an influence on an optical system. Therefore, the substrates 2 and 6 are each preferably a transparent substrate configured to sufficiently transmit visible light. A grass material is generally used, and an optical glass substrate such as Corning #7059 or BK-7 may be preferably used. In addition, even a material such as plastic or ceramic may be appropriately used as long as the material has sufficient transparency. The substrates 2 and 6 are each preferably formed of a rigid material with less distortion. In addition, the substrates each more preferably have less flexibility. In general, the substrates 2 and 6 each have a thickness of from several tens of micrometers to several millimeters.

<Electrodes 3 and 5>

In the case of using the EC element as a light control element, it is preferred that the EC element keep a high transmittance in a decolored state in order to reduce an influence on an optical system. Therefore, the electrodes 3 and 5 are each preferably a transparent electrode configured to sufficiently transmit visible light. The electrodes 3 and 5 are each more preferably formed of a material having a high light transmitting property in a visible light region and high electroconductivity. Examples of such material may include: metals and metal oxides such as indium tin oxide alloy (ITO), tin oxide (NESA), indium zinc oxide (IZO), silver oxide, vanadium oxide, molybdenum oxide, gold, silver, platinum, copper, indium, and chromium; silicon-based materials such as polycrystalline silicon and amorphous silicon; and carbon materials such as carbon black, graphene, graphite, and glassy carbon. In addition, an electroconductive polymer having its electroconductivity improved through, for example, doping treatment (such as polyaniline, polypyrrole, polythiophene, polyacetylene, polyparaphenylene, or a complex of polyethylene dioxythiophene and polystyrene sulfonate (PEDOT:PSS)) may also suitably be used. The EC element of the present invention preferably has a high transmittance in a decolored state, and hence, for example, ITO, IZO, NESA, PEDOT:PSS, or graphene is particularly preferably used. These materials may be used in various forms such as a bulk form and a fine particle form. Note that, one of these electrode materials may be used alone, or a plurality thereof may be used in combination.

<EC Layer 7>

The EC layer 7 is preferably an EC layer in which an electrolyte and at least one kind of organic EC material such as a low-molecular organic material are dissolved in a solvent.

The solvent is not particularly limited as long as the solvent can dissolve the electrolyte, but a polar solvent is particularly preferred. Specific examples thereof include water as well as organic polar solvents such as methanol, ethanol, propylene carbonate, ethylene carbonate, dimethyl sulfoxide, dimethoxyethane, acetonitrile, γ-butyrolactone, γ-valerolactone, sulfolane, dimethylformamide, dimethoxyethane, tetrahydrofuran, acetonitrile, propionitrile, dimethylacetamide, methylpyrrolidinone, and dioxolane.

The electrolyte is not particularly limited as long as the electrolyte is an ion dissociative salt exhibiting satisfactory solubility and including a cation or anion having an electron-donating property to the extent that the coloration of the organic EC material can be ensured. Examples thereof include various inorganic ion salts such as alkali metal salts and alkaline earth metal salts, quaternary ammonium salts, and cyclic quaternary ammonium salts. Specific examples thereof include: salts of alkali metals such as Li, Na, and K, e.g., LiClO₄, LiSCN, LiBF₄, LiAsF₆, LiCF₃SO₃, LiPF₆, LiI, NaI, NaSCN, NaClO₄, NaBF₄, NaAsF₆, KSCN, and KCl; and quaternary ammonium salts and cyclic quaternary ammonium salts such as (CH₃)₄NBF₄, (C₂Hs)₄NBF₄, (n-C₄H₉)₄NBF₄, (C₂Hs)₄NBr, (C₂Hs)₄NClO₄, and (n-C₄H₉)₄NClO₄. In addition, an ionic liquid may also be used. One of these electrolyte materials may be used alone, or a plurality thereof may be used in combination.

As the organic EC material, any material may be used as long as the material has solubility in the solvent and can express coloration and decoloration through an electrochemical reaction. A known organic EC material to be colored through oxidation/reduction may be used. In addition, a plurality of such materials may be used in combination. That is, the organic EC element according to an embodiment of the present invention may include a plurality of kinds of EC materials.

Regarding the combination of the organic EC material, there may be used one kind or a plurality of kinds of anodic materials each showing coloration through an oxidation reaction, or one kind or a plurality of kinds of cathodic materials each showing coloration through a reduction reaction. In addition, the anodic material and the cathodic material may be used as a combination of one kind each of these materials, a combination of one kind of one of the materials and a plurality of kinds of the other materials, or a combination of a plurality of kinds each of these materials. The combination is arbitrary.

Specific examples of the organic EC material to be used may include: organic dyes such as a viologen dye, a styryl dye, a fluoran dye, a cyanine dye, and an aromatic amine dye; and organometallic complexes such as a metal-bipyridyl complex and a metal-phthalocyanine complex.

Specific examples of the cathodic EC material include: viologen-based compounds such as N,N′-diheptylbipyridinium diperchlorate, N,N′-diethylbipyridinium dihexafluorophosphate, N,N′-dibenzylbipyridinium ditetrafluoroborate, N,N′-diphenylbipyridinium dihexafluorophosphate; anthraquinone-based compounds such as 2-ethylanthraquinone, 2-t-butylanthraquinone; ferrocenium salt-based compounds such as ferrocenium tetrafluoroborate, ferrocenium hexafluorophosphate; styryl-based compounds. But the cathodic EC materials to use for this invention are not things limited to these.

Specific examples of the anodic EC material include: thiophene derivatives; metallocene derivatives such as ferrocene; aromatic amine derivatives such as phenazine derivatives, triphenylamine derivatives, phenothiazine derivatives, phenoxazine derivatives; pyrrole derivatives; pyrazoline derivatives. But the anodic EC materials to use for this invention are not things limited to these.

Of those materials, a compound represented by the following general formula [1] is preferred because generated cations do not cause association with each other. A composition in which a plurality of the compounds each represented by the following general formula [1] are mixed is more preferred.

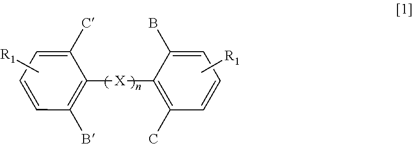

In the formula, B, B′, C, and C′ are each independently selected from an alkyl group having 1 or more to 20 or less carbon atoms, an alkoxy group having 1 or more to 20 or less carbon atoms, and an aryl group that may have a substituent.

R₁ represents a hydrogen atom or a substituent.

n represents an integer of from 1 to 5.

X represents a structure represented by the following general formula [2] or [3], and when n represents an integer of 2 or more, X's are each independently selected from the structures represented by the following general formulae [2] and [3].

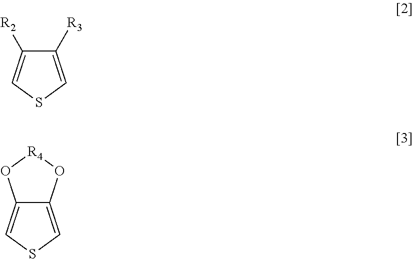

In the formulae, R₂ and R₃ are each independently selected from a hydrogen atom, an alkyl group having 1 or more to 20 or less carbon atoms, an alkoxy group having 1 or more to 20 or less carbon atoms, an aryl group that may have a substituent, and an alkyl ester group having 1 or more to 20 or less carbon atoms; and R₄ represents an alkylene group having 1 or more to 20 or less carbon atoms.

In addition, when a thiophene ring adjacent to an aromatic ring having the groups B, B′, C, and C′ in the general formula [1] is represented by the general formula [2], R₂ and R₃ each represent a substituent other than a hydrogen atom.

Examples of the substituent that the aryl group represented by any one of B, B′, C, and C′ may have include an alkyl group having 1 or more to 4 or less carbon atoms and an alkoxy group having 1 or more to 4 or less carbon atoms. In addition, examples of the substituent represented by R₁ include a halogen atom, an alkyl group having 1 or more to 20 or less carbon atoms, an alkoxy group having 1 or more to 20 or less carbon atoms, an alkyl ester group having 1 or more to 20 or less carbon atoms, an aryl group that may have a substituent, an amino group that may have a substituent, and a cyano group, and the aryl group and the amino group may each have as a substituent an alkyl group having 1 or more to 4 or less carbon atoms. In addition, examples of the substituent that the aryl group represented by R₂ or R₃ may have include an alkyl group having 1 or more to 4 or less carbon atoms and an alkoxy group having 1 or more to 4 or less carbon atoms.

Specific examples of the compound represented by the general formula [1] include the following compounds 1 to 3.

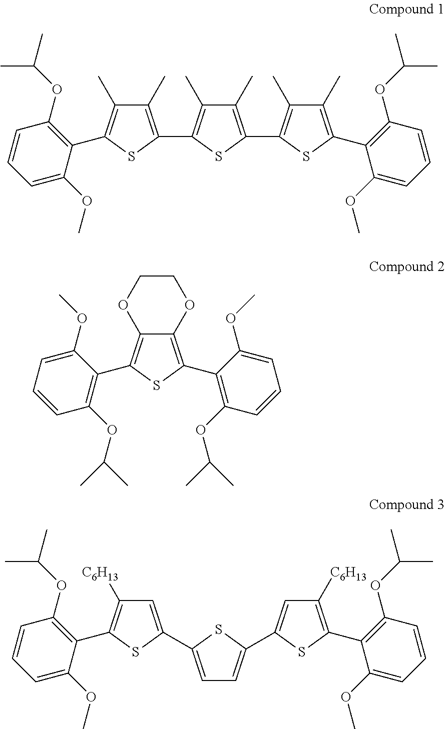

The compound represented by the general formula [1] includes: a portion X exhibiting EC characteristics and having a structure including a thiophene ring; and aromatic rings each having substituents at positions 2 and 6 (B and C, and B′ and C′) on terminal portions of the structure represented by X. Of thiophene rings in the structure represented by X, a thiophene ring adjacent to each aromatic ring on the terminal portion has at positions 3 and 4 the substituents (R₂ and R₃) other than a hydrogen atom, such as the alkyl group, or has at these positions the alkylene dioxy group (R₄).

The plane of each aromatic ring on the terminal portion is twisted with respect to the plane of the thiophene ring in the structure represented by X through steric hindrance between the substituents of the aromatic ring on the terminal portion and the substituents at positions 3 and 4 of the thiophene ring adjacent to the aromatic ring on the terminal portion. A driving force for causing association is considered to be π-π interaction between a thiophene molecule and another thiophene molecule each exhibiting EC characteristics and forming radical cations. As described above, the aromatic ring on the terminal portion has a molecular structure twisted with respect to the plane of the thiophene ring, and hence the thiophene ring is prevented from being close to another thiophene ring of another organic EC molecule through the steric hindrance with the aromatic ring on the terminal portion and its substituents B and C, or B′ and C′. Thus, association is not caused.

In the investigations made by the inventors of the present invention, association is not visually observed to be formed in the compound represented by the general formula [1]. A material that causes association shows different behavior of absorption change between cations and cations in an associated form at the time of coloring and decoloring. As a result, an absorption spectrum largely changes in some cases. However, the light transmittance of the compound represented by the general formula [1] can be controlled in both a coloring direction and a decoloring direction while the shape of the absorption spectrum is maintained. Note that, even the material that causes association may be mixed with the compound represented by the general formula [1] when absorption shown by the material in an associated form in itself is not so high as to be visually observed, and does not affect the absorption spectrum.

The EC layer 7 may be an EC layer in which an inorganic EC material is dispersed in a solution. Examples of the inorganic EC material may include tungsten oxide, vanadium oxide, molybdenum oxide, iridium oxide, nickel oxide, manganese oxide, and titanium oxide.

The EC layer 7 is preferably a liquid or a gel. The EC layer 7 is suitably used in a solution state, but may also be used in a gel state. Gelling is carried out by further incorporating a polymer or a gelling agent into a solution. Examples of the polymer (gelling agent) include, but not particularly limited to, polyacrylonitrile, carboxymethylcellulose, polyvinyl chloride, polyvinyl bromide, polyethylene oxide, polypropylene oxide, polyurethane, polyacrylate, polymethacrylate, polyamide, polyacrylamide, polyester, polyvinylidene fluoride, and Nafion. Thus, the EC layer 7 may be used in a viscous state, a gel state, or the like.

In addition, the EC layer may be used in a state in which the solution is supported by a structural body having a transparent and flexible network structure (for example, a sponge-like one), other than in the mixed state as described above.

(Drive Apparatus and Drive Method)

In FIG. 1, the drive apparatus includes the drive power supply 8, the resistor switch 9, and the controller 10. The drive apparatus applies a continuous drive pulse to the EC element 1, and uses a duty ratio of the drive pulse to change the absorbance of the EC element.

The drive power supply 8 applies, to the EC element 1, a voltage (drive voltage V1) for causing at least one of the oxidation reaction and reduction reaction of the EC material. When the EC layer 7 contains one type of EC material, the value of V1 may be changed substantially within such a range as to cause a normal electrochemical reaction. On the other hand, when the EC layer 7 contains a plurality of types of EC materials, it is preferred that V1 be a constant voltage because an absorption spectrum may change due to a difference in oxidation-reduction potential or molar absorption coefficient among the EC materials. In view of both of the cases, it is more preferred that the drive voltage V1 be a constant voltage. The voltage application of the drive power supply 8 is started based on a signal of the controller 10, and a state in which the voltage is applied is maintained based also on the signal of the controller 10. In the present invention, during a period in which the light transmittance of the EC element 1 is controlled, the state in which the constant voltage is applied is maintained.

The resistor switch 9 switches a resistor R1, which is to be connected during an applied period, and a resistor R2, which has a resistance value larger than that of the resistor R1, from one to another, and connects the selected one of the resistors in series to a closed circuit including the drive power supply 8 and the EC element 1. It is preferred that a resistance value of the resistor R1 be smaller than at least the largest impedance in the element closed circuit, and the resistance value is preferably 10Ω or smaller. It is preferred that the resistance value of the resistor R2 be larger than the largest impedance in the element closed circuit, and the resistance value is preferably 1 MΩ or larger. Further, the resistor R2 may be assumed to be air. In this case, the closed circuit is an open circuit in a strict sense, but when the air is assumed as the resistor R2, the open circuit is equivalent to the closed circuit.

The controller 10 sends a switch signal to the resistor switch 9 to control the switching between the resistor R1 and the resistor R2.

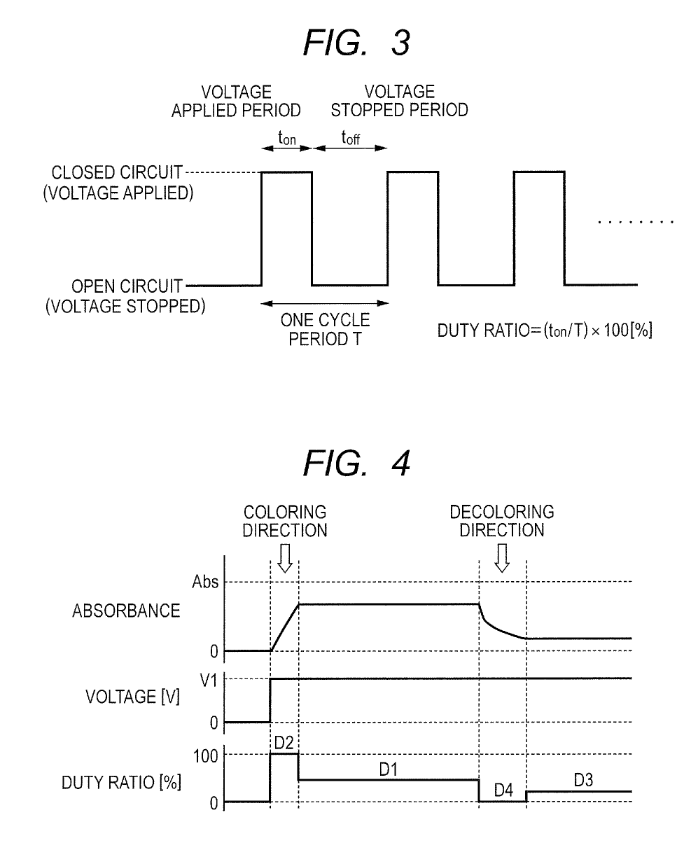

FIG. 3 is a diagram for illustrating a voltage application method according to the present invention. A drive pulse illustrated in FIG. 3 has one cycle T including an applied period tₒₙ of the drive voltage V1 and a stopped period t_{off} thereof. The stopped period t_{off} is a period in which in the closed circuit including the EC element 1, the resistor R2, which has the resistance value larger than that of the resistor R1 to be connected during the applied period tₒₙ, is connected in series. In addition, the duty ratio is a ratio of the applied period tₒₙ of the drive voltage V1 to the one cycle.

A condition necessary to maintain a written state of the EC element 1 through the duty drive is that a current is caused to flow through an external circuit during the applied period tₒₙ of the drive voltage V1 but the current is not caused to flow through the external circuit during the stopped period t_{off}. The EC element 1 has such a characteristic that when a forward current is caused to flow, the current causes a reaction and the EC element 1 is thus colored, but when the current is caused to flow in a reverse direction, a reverse reaction is caused and the EC element 1 is thus decolored. Considering this, when a potential difference between the electrodes is decreased during the stopped period t_{off}, a sudden decoloring reaction occurs, and the written state cannot be maintained as a result. However, by inserting the resistor to the external circuit portion of the EC element 1 in series during the stopped period t_{off}, it is possible to suppress the current flowing through the external circuit. In this manner, it is possible to suppress a sudden decoloring reaction, to thereby maintain the written state. Under the state in which the resistor is inserted to the external circuit in series, only a current generated by diffusion of the EC molecules between the electrodes flows between the electrodes, and hence an amount of current generated by a reverse reaction is small, which reduces a fluctuation of the written state. Therefore, a fixed absorbance can be maintained by applying a certain duty ratio. In other words, the stopped period t_{off} as used herein does not mean a period in which the voltage is not applied, but means a period in which the current is not caused to flow through the external circuit of the EC element 1 and the potential difference between the electrodes is not attenuated actively. Accordingly, even if the resistance value of the external resistor R2 inserted during the stopped period t_{off} is significantly large and the potential difference between the electrodes is the same during both of the applied period tₒₙ and the stopped period t_{off} of the drive voltage V1, the voltage is applied continuously but the current is not caused to flow. Therefore, the oxidation or reduction reaction of the EC material does not occur. Thus, during the stopped period t_{off}, only a gradual reverse reaction occurs, and a sudden change in light amount does not occur. This point greatly differs in principle from a liquid crystal element, which is driven based on an effective voltage value and, even if a current does not flow through the element, makes an electrochemical response when a voltage is applied to the element. Therefore, a written amount of the liquid crystal element cannot be controlled based on such a drive method as described in the present invention.

More specifically, in FIG. 3, from a starting point of drive, the drive power supply 8 applies, to the EC element 1, the voltage (drive voltage V1) for causing at least one of the oxidation reaction or reduction reaction of the EC material. When receiving the signal from the controller 10, the resistor switch 9 switches the resistor R1 and the resistor R2 from one to another, and connects the selected one of the resistors to the closed circuit including the EC element 1 and the drive power supply 8. When the resistor switch 9 switches a state of wiring connection between a connected state and a disconnected state as illustrated in FIG. 1, the circuit state is switched between the closed circuit state and the open circuit state based on the operation of the resistor switch 9 as illustrated in FIG. 3. The closed circuit state is a voltage applied state, and the open circuit state is a state in which the resistor R2 is inserted to the power supply in series (this state is hereinafter referred to as “stopped state”). In the voltage applied state, the EC element 1 exhibits a coloring reaction. In the stopped state, the EC element 1 exhibits a “self-decoloring phenomenon”, in which the colored material is decolored. The self-decoloring phenomenon is caused by, for example, instability of the cation or anion of the EC material generated by the electrochemical reaction, or diffusion of the cation or the anion to a counter electrode having a different potential. When a certain duty ratio is given, the absorbance changes until a balance is reached between a colored amount and a self-decoloring amount, and then the balanced absorbance is maintained. The magnitude of the absorbance can be controlled through the application and stop of such a pulse drive of the drive voltage V1, namely, through an intermittent drive of the drive voltage V1, because the EC element, in particular, the organic EC element, has the self-decoloring phenomenon. Accordingly, it follows that the above-mentioned drive method is a method suitable for the organic EC element. Note that, the drive voltage V1 is supplied during both of the applied period and the stopped period without changing its value.

The switching between the voltage application and the stop of voltage application is controlled by the controller 10, and the controller 10 sends, to the resistor switch 9, the continuous pulse having the one cycle T corresponding to a sum of the applied period tₒₙ and the stopped period t_{off}. Now, the ratio of the applied period tₒₙ to the one cycle T is defined as the duty ratio. When the EC element 1 is driven at a fixed duty ratio under the constant voltage of the drive power supply 8 as illustrated in FIG. 3, a change in absorbance is saturated after passing through the transitional state, and then the saturated absorbance is maintained. In order to decrease the absorbance, it is only necessary that the duty ratio be fixed to the one smaller than the last duty ratio. Further, in order to increase the absorbance, it is only necessary that the duty ratio be fixed to the one larger than the last duty ratio.

The controller 10 has a characteristic table about a duty ratio and the absorbance to be reached with the duty ratio for at least each of the coloring direction and the decoloring direction, namely, has at least two such characteristic tables. In normal drive, the controller 10 selects a duty ratio D1, which is required for the absorbance to reach a target absorbance. When the one cycle T of the control signal is long, an increase or decrease of an absorbance change is viewable in some cases, and hence an upper limit of the one cycle T is at least 100 milliseconds or shorter, preferably 10 milliseconds or shorter. Further, a lower limit of the one cycle T is determined so that the lower limit falls within such a range as to enable the electrochemical reaction to follow the cycle, and the lower limit is 1 microsecond or longer, preferably 10 microseconds or longer. It is preferred that the one cycle T be fixed, but a certain deviation within the above-mentioned range is tolerated in some cases.

FIG. 4 is a diagram for illustrating one drive control mode of the drive method according to the present invention.

As illustrated in FIG. 4, in the present invention, when the absorbance of the EC element 1 is to be increased from a current absorbance to the target absorbance, accelerated drive is performed immediately before normal drive under the state in which the drive voltage V1 is applied. In this case, the normal drive is drive performed at the duty ratio D1 to maintain the target absorbance, and the accelerated drive is drive performed at a duty ratio D2, which is larger than the duty ratio D1. In this manner, a length of time spent for the transitional state in the coloring direction can be shortened, with the result that the operating performance of the EC element 1 can be enhanced. In this case, it is preferred that the duty ratio D2 be 100%, which enhances the acceleration most.

Further, when the absorbance of the EC element 1 is to be decreased from a current absorbance to a target absorbance, it is preferred that accelerated drive be performed immediately before normal drive under the state in which the drive voltage V1 is applied. In this case, the normal drive is drive performed at a duty ratio D3 to maintain the target absorbance, and the accelerated drive is drive performed at a duty ratio D4, which is smaller than the duty ratio D3. In this manner, a length of time spent for the transitional state in the decoloring direction can be shortened, with the result that the operating performance of the EC element 1 can be enhanced. In this case, it is preferred that the duty ratio D4 be 0%, which enhances the acceleration most.

In this case, the process in which the duty ratio is 0% is a process of inserting the resistor to the external circuit without changing the power supply voltage, thereby causing the EC element to be decolored through the self-decoloring without causing the electrode reaction of the EC material. However, only at the time of decoloring, it is also possible to feed the electric power at such a potential as to cause the oxidation or reduction or less (e.g., 0 V), and not to connect the resistor to the external circuit. Note that, when there is one drive power supply, the drive power supply does not necessarily supply power only to the organic EC element, but supplies the power also to the controller, the resistor switch, and other peripheral devices. In such a system, it is not preferred to change the drive power supply itself, and it is desired that as in the present invention, the duty ratio be controlled under the state in which the power from the drive power supply is being supplied.

A method of applying a voltage higher than a normal voltage during the transitional state to accelerate the element operation, such as an overdrive technology for liquid crystal, is not necessarily preferred in, for example, the organic EC element containing the plurality of types of EC materials. This is because due to a difference in oxidation-reduction potential or molar absorption coefficient among the EC materials, the absorption spectrum changes relative to the voltage in some cases.

Further, through the use of the method and apparatus for driving an organic EC element according to the present invention, it is possible to define a period of the accelerated drive in the accelerated drive in the coloring direction.

In general, the speed of an electrode reaction of an organic material is affected by a charge-transfer process between a reactant and an electrode and a mass transfer process in which a reactant is supplied to an electrode interface. When an overvoltage enough to cause the electrochemical reaction of the organic material is applied to the electrode, the charge-transfer process has a time constant on the order of microseconds, and is a process that progresses overwhelmingly faster than the mass transfer process. Therefore, the electrode reaction is rate-controlled by the mass transfer process. Further, when the organic EC element is placed under a stationary environment, the mass transfer is determined based mainly on diffusion of a material.

In the field of electrochemistry, it is known that a change with time in diffusion current under a constant potential follows a Cottrell equation of Formula (1).

$$i ( t ) = \frac{{zFD}_{0} {C}_{0}}{\sqrt{π {D}_{0}}} \frac{1}{\sqrt{t}} \qquad ( 1 )$$

In Formula (1), i(t) represents the diffusion current under the constant potential, z represents the number of reaction electric charges, F represents the Faraday constant, D₀ represents a diffusion coefficient of an organic material before reaction, and C₀ represents a concentration of the organic material before reaction in the bulk separated from the electrode interface.

Further, an amount of change in absorbance in the coloring direction is represented by a Lambert-Beer equation of Formula (2).

ΔAbs=ε·ΔC(t)·L (2)

In Formula (2), ΔAbs represents the amount of change in absorbance, ε represents a molar absorption coefficient of an organic material after reaction, ΔC(t) represents an amount of change in concentration of the organic material after reaction, and L represents an optical path length. In this case, ΔC(t) is proportional to a current amount, and hence ΔC(t) is proportional to a time integral of i(t) of Formula (1), and a relationship of Formula (3) is established.

$$Δ C ( t ) = k \int i ( t ) d t = 2 {k}^{′} {zFC}_{0} \sqrt{\frac{{D}_{0}}{π}} \sqrt{t} \qquad ( 3 )$$

In Formula (3), k and k′ represent proportionality constants.

Considering this, it can be understood that in the drive in the coloring direction, a square (ΔAbs)² of a change in absorbance is proportional to a drive time t.

Note that, in the drive method of the present invention, the one cycle of the continuous pulse includes the voltage stopped period, and hence diffusion limitation of a material tends to be alleviated. However, the drive method still includes the relationship of the diffusion limitation in the case of the above-mentioned period of time of the one cycle of the continuous pulse. Therefore, the proportional relationship between (ΔAbs)² and the drive time t is established.

Considering this, by applying the proportional relationship between (ΔAbs)² and t to the accelerated drive in the coloring direction, a period required for the accelerated drive can be calculated based on an amount of change between the current absorbance and the target absorbance.

Now, when arbitrary two absorbance change amounts in the accelerated drive are represented by ΔQₘ and ΔQₙ, and periods of the accelerated drive that are required for the arbitrary two absorbance change amounts ΔQₘ and ΔQₙ, are represented by Tₘ and Tₙ, respectively, from the proportional relationship between (ΔAbs)² and t, ΔQm²/Tm=ΔQn²/Tn is established. Therefore, a relationship of Formula (4) is established.

$${T}_{m} = {( \frac{Δ {Q}_{m}}{Δ {Q}_{n}} )}^{2} {T}_{n} \qquad ( 4 )$$

If Tₘ, which is the period of the accelerated drive, is set as shown in Formula (5), drive that causes an absorbance change amount exceeding a necessary amount is performed as a result. In other words, the accelerated drive is performed even after the target absorbance is reached.

$${T}_{m} > {( \frac{Δ {Q}_{m}}{Δ {Q}_{n}} )}^{2} {T}_{n} \qquad ( 5 )$$

In this case, the absorbance temporarily becomes larger than the target absorbance, and decreases a little during the process of the subsequent normal drive. Then, the absorbance is saturated at the target absorbance. This is not preferred because in addition to a time loss, an unnecessary rebound of the absorbance is caused. Therefore, it is preferred that Tₘ, which is the period of the accelerated drive, be controlled under a relationship of Formula (a).

$${T}_{m} \leq {( \frac{Δ {Q}_{m}}{Δ {Q}_{n}} )}^{2} {T}_{n} \qquad ( 6 )$$

In Formula (a), under a relationship of Tm<(Right Term), the accelerated drive ends before the absorbance reaches the target absorbance, and the absorbance increases a little during the process of the subsequent normal drive. Then, the absorbance is saturated at the target absorbance. This case is preferred as compared with the case of Formula (5) because there is no rebound of the absorbance.

Further, the control of the period of the transitional state can also be achieved as follows. Specifically, (ΔQ)²/t is acquired in advance. (ΔQ)²/t is a slope of a line that is obtained by linearly approximating a relationship between a square of an absorbance change amount ΔQ and the time t of acceleration at the time of the accelerated drive. Then, when the absorbance of the EC element 1 is to be increased from the current absorbance to the target absorbance, a drive time t₁ corresponding to a change amount of the absorbance is calculated based on the slope (ΔQ)²/t, and a period t₀ of the accelerated drive is set so as to satisfy t_{A}≦t₁.

In this example, the period of the accelerated drive is set based on the difference between the magnitudes of the current absorbance and the target absorbance. A value of the current absorbance may be any value. Further, in a drive method in which when the absorbance is to be changed, the EC element is always returned to the initial state (reset state) and then controlled to be the target absorbance, the initial state can be set as a reference. Therefore, this drive method has an advantage in that time setting is facilitated more, and is applicable depending on a mode of use.

<<Optical Filter>>

An optical filter according to the present invention includes an EC element and the above-mentioned apparatus for driving the EC element according to the present invention. Specifically, the optical filter is, for example, an example in which the EC apparatus illustrated in FIG. 1 is applied as the optical filter, and the optical filter may include a peripheral device. The optical filter may be used in an image pickup apparatus such as a camera. When used in the image pickup apparatus, the optical filter may be arranged in a main body of the image pickup apparatus, or may be arranged in a lens unit. Now, a case is described where a neutral density (ND) filter is formed as the optical filter.

The neutral density filter absorbs black, and needs uniform light absorption in a visible light region. In order to realize the black absorption with the use of the organic EC material, it is only necessary that a plurality of materials having different absorption regions in the visible light region be mixed to make absorption flat in the visible light region. The absorption spectrum in the case of mixing the organic EC materials is expressed by a sum of the absorption spectra of the respective materials, and hence the black absorption can be realized by selecting a plurality of materials having appropriate wavelength regions and adjusting concentrations thereof. What is important in this case is that none of the organic EC materials causes association or that the organic EC element is formed only of materials that do not have a significant influence even when causing association.

An example of driving the neutral density (ND) filter according to the present invention is described below. In general, the neutral density (ND) filter reduces an amount of light to ½ⁿ (where n is an integer). When the amount of light is reduced to ½, the transmittance is reduced from 100% to 50%. When the amount of light is reduced to ¼, the transmittance is reduced from 100% to 25%. Further, when the transmittance is reduced to ½, from a relationship of −LOG(transmittance)=(absorbance), the absorbance change amount is 0.3, and when the transmittance is reduced to ¼, the absorbance change amount is 0.6. In order to reduce the light amount so that the transmittance varies from ½ to 1/64, it is only necessary that the absorbance change amount be controlled to be from 0 to 1.8 in units of 0.3.

When the EC layer is in a solution state, the absorbance change amount includes a change amount of the colored amount that is caused by a fluctuation of the solution. In order to achieve accurate control, the optical filter may be equipped with an external monitor configured to measure a light amount as a part of the optical filter.

<<Image Pickup Apparatus and Lens Unit>>

An image pickup apparatus according to the present invention includes the above-mentioned optical filter according to the present invention and a light receiving element configured to receive light that has been transmitted through the optical filter.

Further, a lens unit according to the present invention includes the above-mentioned optical filter according to the present invention and an optical system including a plurality of lenses. The optical filter may be arranged so that the light that has been transmitted through the optical filter is then transmitted through the optical system. Alternatively, the optical filter may be arranged so that the light that has been transmitted through the optical system is then transmitted through the optical filter.

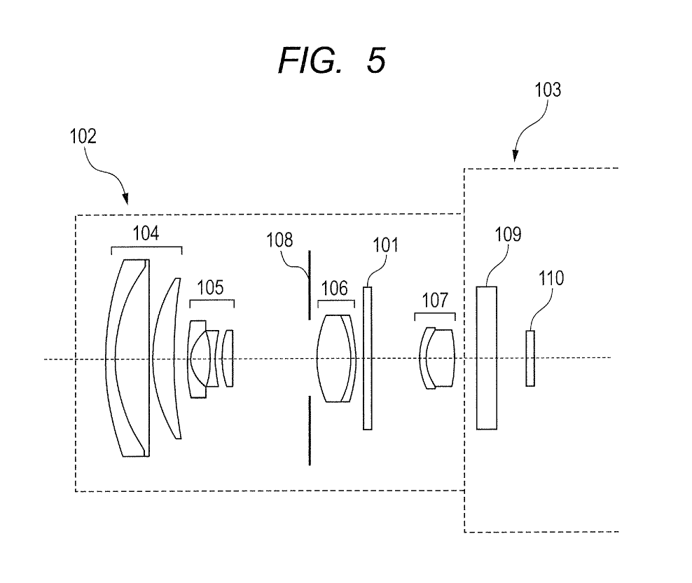

FIG. 5 is a schematic diagram for illustrating the image pickup apparatus including the lens unit using the optical filter according to the present invention. As illustrated in FIG. 5, a lens unit 102 is removably connected to an image pickup apparatus 103 through a mount member (not shown).

The lens unit 102 is a unit including a plurality of lenses or lens groups. For example, the lens unit 102 illustrated in FIG. 5 is a rear-focus zoom lens configured to perform focusing behind a diaphragm. The lens unit 102 includes, in order from a subject side (left side of the drawing), four lens groups of a first lens group 104 having a positive refractive power, a second lens group 105 having a negative refractive power, a third lens group 106 having a positive refractive power, and a fourth lens group 107 having a positive refractive power. An interval between the second lens group 105 and the third lens group 106 is changed to vary magnification, and a part of lenses of the fourth lens group 107 is moved to perform focusing. For example, the lens unit 102 includes a diaphragm 108 arranged between the second lens group 105 and the third lens group 106, and further includes an optical filter 101 arranged between the third lens group 106 and the fourth lens group 107. Those components are arranged so that the light to be transmitted through the lens unit 102 is transmitted through the lens groups 104 to 107, the diaphragm 108, and the optical filter 101, and the amount of light can be adjusted with the use of the diaphragm 108 and the optical filter 101.

Further, a configuration of the components of the lens unit 102 can be modified appropriately. For example, the optical filter 101 may be arranged in front of the diaphragm 108 (on the subject side thereof), or may be arranged behind the diaphragm 108 (on the image pickup apparatus 103 side thereof). Alternatively, the optical filter 101 may be arranged in front of the first lens group 104, or may be arranged behind the fourth lens group 107. When the optical filter 101 is arranged at a position where light converges, there is an advantage in that an area of the optical filter 101 can be reduced, for example. Further, a mode of the lens unit 102 can also be selected appropriately. Instead of the rear-focus zoom lens, the lens unit 102 may also be an inner-focus zoom lens configured to perform focusing in front of the diaphragm, or may be another type of zoom lens configured to perform focusing in another way. Further, instead of the zoom lens, a special-purpose lens such as a fisheye lens or a macro lens can also be selected appropriately.

A glass block 109 of the image pickup apparatus is a glass block such as a low-pass filter, a face plate, or a color filter. Further, a light receiving element 110 is a sensor unit configured to receive light that has been transmitted through the lens unit 102, and an image pickup element such as a CCD or a CMOS may be used as the light receiving element 110. Further, the light receiving element 110 may also be an optical sensor such as a photodiode, and a device configured to acquire and output information on intensity or wavelength of light can be used appropriately as the light receiving element 110.

When the optical filter 101 is built into the lens unit 102 as illustrated in FIG. 5, the drive apparatus may be arranged within the lens unit 102, or may be arranged outside the lens unit 102. When the drive apparatus is arranged outside the lens unit 102, the EC element and the drive apparatus, which are respectively arranged within and outside the lens unit 102, are connected to each other through wiring, and the drive apparatus drives and controls the EC element.

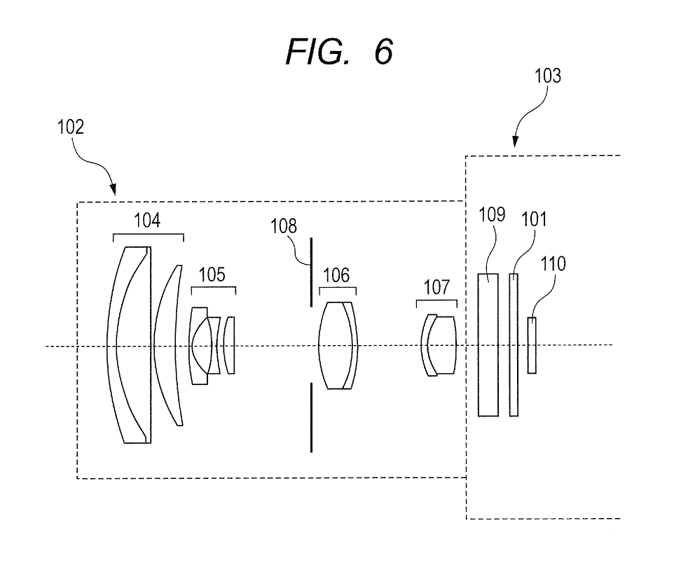

As illustrated in FIG. 6, the image pickup apparatus 103 itself may include the optical filter 101 according to the present invention. FIG. 6 is a schematic diagram of the image pickup apparatus including the optical filter. The optical filter 101 is arranged at an appropriate position within the image pickup apparatus 103, and it is only necessary that the light receiving element 110 be arranged so as to receive the light that has been transmitted through the optical filter 101. In FIG. 6, for example, the optical filter 101 is arranged immediately in front of the light receiving element 110. When the image pickup apparatus 103 itself has the optical filter 101 built therein, the lens unit 102 itself connected to the image pickup apparatus 103 does not need to include the optical filter 101, and hence it is possible to form the image pickup apparatus using an existing lens unit and being capable of controlling light.

The image pickup apparatus described above is applicable to a product having a combination of a function of adjusting a light amount and a light receiving element. The image pickup apparatus can be used in, for example, a camera, a digital camera, a video camera, or a digital video camera. The image pickup apparatus is also applicable to a product having the image pickup apparatus built therein, such as a mobile phone, a smartphone, a PC, or a tablet computer.

Through the use of the optical filter according to the present invention as a light control member, it is possible to appropriately vary a light amount to be controlled with the use of one filter, and there is an advantage in that the number of members can be reduced and that a space can be saved, for example.

<<Window Member>>

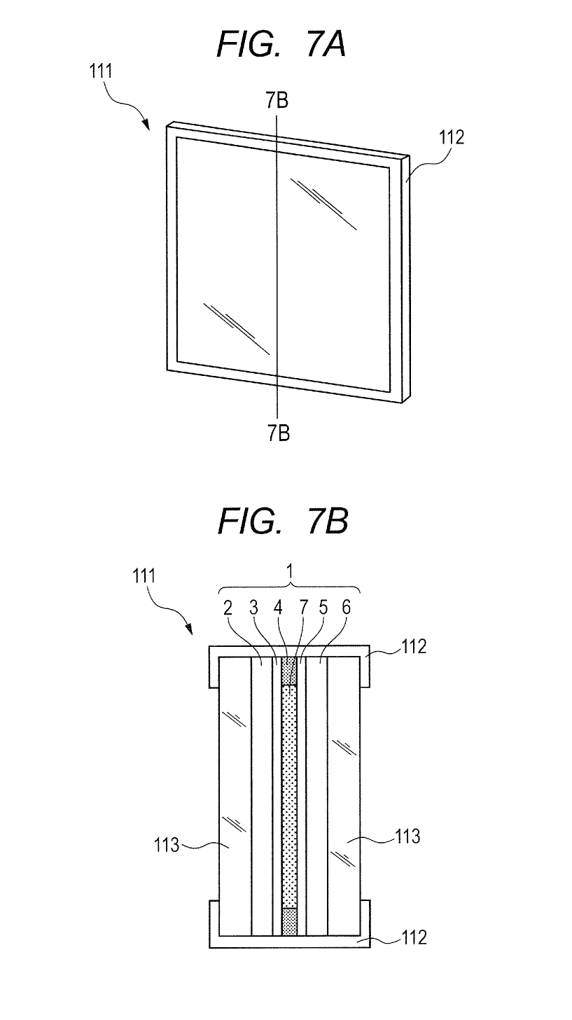

A window member according to the present invention includes an EC element and the above-mentioned apparatus for driving the EC element according to the present invention. FIG. 7A and FIG. 7B are views each for illustrating the window member according to the present invention. FIG. 7A is a perspective view of the window member, and FIG. 7B is a cross-sectional view taken along the line 7B-7B of FIG. 7A.

The window member 111 of FIG. 7A and FIG. 7B is a light control window, and includes the EC element 1, transparent plates 113 for sandwiching the EC element 1 therebetween, and a frame 112 for surrounding the entire window member to integrate those components into one window member. The drive apparatus may be built into the frame 112, or may be arranged outside the frame 112 and connected to the EC element 1 through wiring.

The transparent plates 113 are not particularly limited as long as being made of a material having a high light transmittance. Considering the use of the window member 111 as a window, it is preferred that the transparent plates 113 be made of glass materials. In FIG. 7A and FIG. 7B, the EC element 1 is a constituent member independent of the transparent plates 113, but for example, the substrates 2 and 6 of the EC element 1 may be regarded as the transparent plates 113.

A material property of the frame 112 is not limited, but any member that covers at least a part of the EC element 1 and has a form of being integrated into one frame may be regarded as the frame.

The light control window described above is applicable to, for example, use of adjusting an amount of sunlight entering a room during the daytime. The light control window can be used to adjust not only the amount of sunlight but also a heat quantity, and hence can be used to control brightness and temperature of the room. Further, the light control window is also applicable to use as a shutter to prevent an indoor view from being seen from the outside of the room. The light control window described above is applicable not only to a glass window for a construction, but also to a window of a vehicle such as an automobile, a train, an airplane, or a ship, and to a filter of a display surface of a clock, a watch, or a mobile phone.

### Example 1

In Example 1, the drive apparatus illustrated in FIG. 1 was produced by using as the organic EC material the compound 1, which formed cations from neutral species through an oxidation reaction to be colored.

The EC element 1 had a construction as illustrated in FIG. 2. Two glass FTO substrates (substrates in which the electrodes 3 and 5 each formed of a fluorine-doped tin oxide thin film were formed on the substrates 2 and 6 each made of glass) were bonded to each other through the spacer 4 of 125 μm. The EC layer 7 was present in a space formed by the substrates 2 and 6 and the spacer 4. As the EC layer 7, a solution obtained by dissolving the compound 1 in a propylene carbonate solvent together with a supporting electrolyte (TBAP) was injected. The concentrations of the compound 1 and TBAP were 10 mM and 0.1 M, respectively. When a voltage of 2 V was applied between the electrodes as the drive voltage V1, the compound 1 was oxidized by the electrode on one side (anode) to be colored.

The drive power supply 8 applies the drive voltage V1. Connection between the EC element 1 and the drive power supply 8 was controlled by a switch circuit (relay circuit) serving as the resistor switch 9, and the switch circuit switched the state of wiring connection between the drive power supply 8 and the EC element 1 between the connected state and the disconnected state. Timing for controlling the switch circuit was controlled based on voltage supply from an arbitrary waveform generator. The arbitrary waveform generator can be considered as corresponding to a part of functions of the controller 10. The operation of the switch circuit was the same as connecting one of the low-resistance resistor R1 and the high-resistance resistor R2 to wiring of the EC element 1 in series. In this case, the low-resistance resistor R1 can be regarded as a resistor of a wiring material, and had a resistance value of 10Ω or smaller. Further, the high-resistance resistor R2 was the air, and hence its resistance value far exceeded 1 MΩ.

An amount of current flowing through the circuit was controlled by switching the resistor to be connected to the element circuit between the low-resistance resistor R1 and the high-resistance resistor R2 in this manner. When the element circuit was connected to the low-resistance resistor R1, the current flowed to cause the oxidation reaction. As a result, the EC element was colored. When the element circuit was connected to the high-resistance resistor R2, no current flowed, and hence the oxidation reaction was not caused. At this time, the organic EC element exhibited the self-decoloring phenomenon due to diffusion. Until the balance was reached between the oxidation reaction amount and the self-decoloring amount, the absorbance changed transiently, and after the balance was reached, the balanced absorbance was maintained.

The change of absorbance was measured with the use of a spectrometer (manufactured by Ocean Optics, Inc., USB2000+) capable of measuring absorption in ultraviolet, visible, and near infrared wavelength regions. In the following, unless otherwise noted, the magnitude of the absorbance means an absorbance at a single wavelength corresponding to any one of absorption peaks exhibited by the EC element 1.

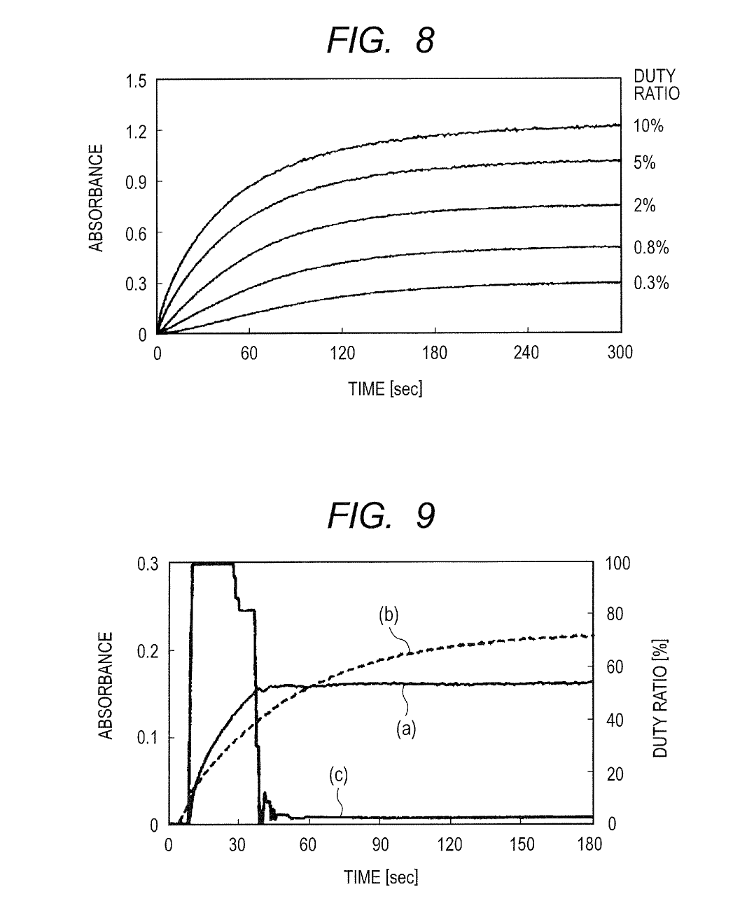

FIG. 8 is a graph for showing a change in absorbance (change exhibited by the compound 1 at the absorption peak at 600 nm) obtained when the EC element was driven at a fixed duty ratio in the coloring direction while assuming the initial state in which the EC element is decolored as a starting point.

As shown in FIG. 8, when the application of the drive voltage V1 and the control at the fixed duty ratio were performed at the same time on the EC element while assuming a state in which the EC element is not colored as the initial state, the EC element changed its magnitude of the absorbance to be reached depending on the magnitude of the duty ratio. Thus, the light transmittance was able to be controlled based on the control of the duty ratio. Further, as the duty ratio became larger, an amount and speed of change in absorbance became larger, and the time spent for the transitional state became shorter.

From this result, by performing the accelerated drive at the duty ratio D2 larger than the duty ratio D1 before the normal drive at the duty ratio D1 for causing the absorbance to reach the target absorbance and maintaining the target absorbance, it is possible to enhance the operating performance in the coloring direction.

FIG. 9 is a graph for showing a change with time in absorbance of the EC element obtained when the accelerated drive was used. In FIG. 9, a line “(a)” indicates a change with time in absorbance obtained when the duty ratio D2 was set to 100% in the accelerated drive and the duty ratio D1 was set to 2% in the subsequent normal drive. Timing for controlling the duty ratio is indicated by a line “(c)”. On the other hand, a line “(b)” indicates a change with time in absorbance obtained when the normal drive was performed at the duty ratio of 4% from the initial state without performing the accelerated drive. It is revealed that, as compared with the case of the line “(b)”, time spent for the transitional state was significantly reduced in the case of the line “(a)”, and it is clear that the accelerated drive is highly effective.

### Example 2

In Example 2, a plurality of kinds of materials that formed cations from neutral species through an oxidation reaction to be colored were mixed to be used as the organic EC material. The materials used were the compounds 1 to 3 described above and the following compound 4. The concentrations of the compounds 1 to 4 were 13 mM, 30 mM, 8 mM, and 2 mM, respectively, and other element constructions were the same as in Example 1.

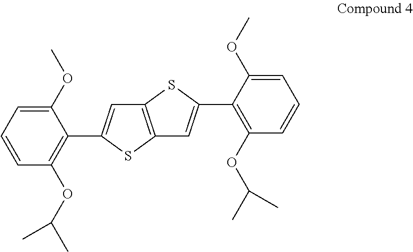 [SMILES: COc1cccc(OC(C)C)c1-c1cc2sc(-c3c(OC)cccc3OC(C)C)cc2s1]

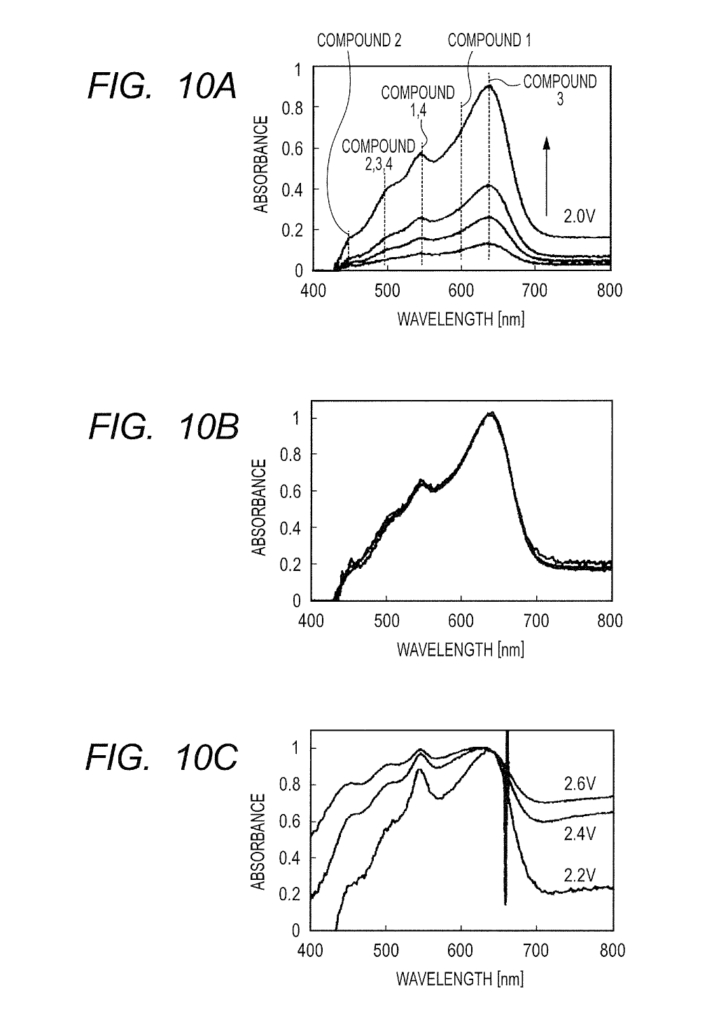

FIG. 10A to FIG. 10C are graphs each for showing an absorption spectrum at the time of driving of the organic EC element.

FIG. 10A is a graph for showing a change in absorption spectrum in a coloring direction at the time of application of a constant voltage of 2.0 V for 3 seconds. Arbitrary four time points were extracted and superposed in one graph. The materials simultaneously reacted, and the compound 1 shows absorption at 540 nm and 600 nm, the compound 2 shows absorption at 440 nm and 490 nm, the compound 3 shows absorption at 500 nm and 630 nm, and the compound 4 shows absorption at 500 nm and 530 nm.

FIG. 10B is a graph in which the absorption spectra at the respective time points shown in FIG. 10A were normalized with reference to 630 nm and superposed on each other. From the fact that the spectra approximately coincide with each other, it is revealed that the absorbance can be changed without changing the absorption spectrum in the case of driving at a constant voltage.

On the other hand, FIG. 10C is a graph in which the absorption spectra at the drive voltages of 2.2 V, 2.4 V, and 2.6 V were normalized with reference to 630 nm and superposed on each other. It is revealed from FIG. 10C that when the drive voltage is changed, the absorption spectrum changes significantly. This was conceivably caused by the difference in oxidation-reduction potential or molar absorption coefficient among the materials.

From this result, it is revealed that when the EC element is the organic EC element, in particular, the organic EC element containing a plurality of types of EC materials, it is preferred that the drive voltage be a constant voltage. Further, by performing the accelerated drive at the duty ratio D2 larger than the duty ratio D1 under the constant drive voltage before the normal drive at the duty ratio D1 for maintaining the target absorbance, it is possible to enhance the operating performance in the coloring direction while maintaining the absorption spectrum.

### Example 3

In Example 3, as the EC layer 7, a solution obtained by dissolving the compound 4 and 1,1′-diethyl-4,4′-bipyridinium dichloride (ethyl viologen) in a propylene carbonate solvent together with a supporting electrolyte (TBAP) was injected. The concentrations of the compound 4 and ethyl viologen were 10 mM and 10 mM, respectively, and other element constructions were the same as in Example 1. Note that, ethyl viologen had a dication structure of a quaternary ammonium salt of 4,4′-bipyridine. When a voltage was applied, a one-electron reduction reaction occurred, and the EC layer changed to blue from transparent. Further, when a reverse voltage was applied, an oxidation reaction occurred in turn, and the EC layer changed from blue back to transparent. In the EC element of Example 3, when a voltage was applied, an oxidation reaction of the compound 4 occurred on one of the electrodes and a reduction reaction of ethyl viologen occurred on the other electrode to cause coloration. In addition, the compound 4 was reduced and ethyl viologen was oxidized to cause decoloration when the element was allowed to short out or a reverse voltage was applied after the coloration.

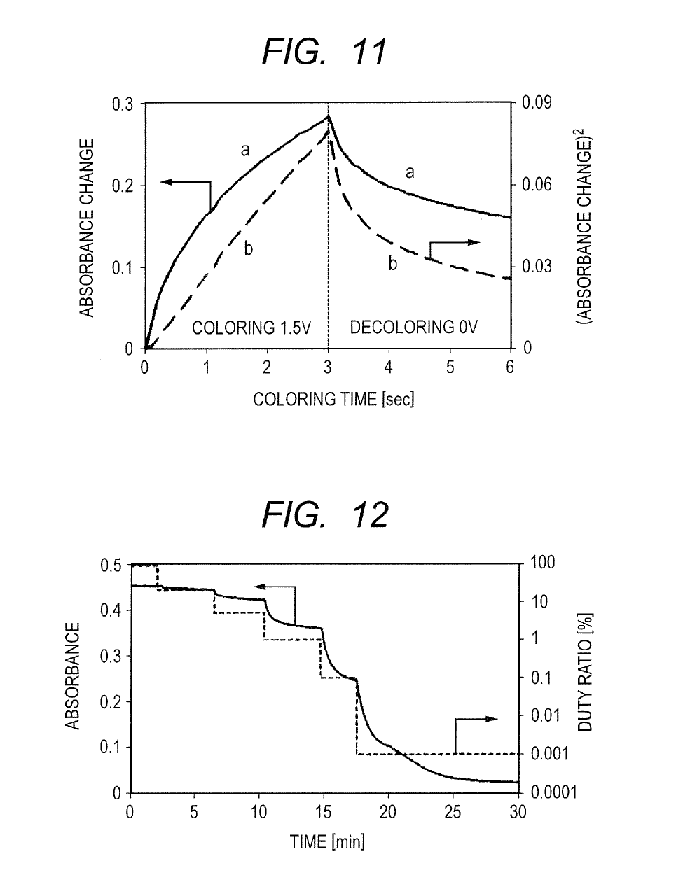

FIG. 11 is graph for showing a relationship between the absorbance change of the EC element and the drive time. In FIG. 11, a line “a” indicates a change with time in absorbance when the drive voltage of 1.5 V was applied at the time of coloring and the drive voltage of 0 V was applied at the time of decoloring. The absorbance is a value obtained at the wavelength of 500 nm, where the compound 4 exhibits absorption. Further, in FIG. 11, a line “b” indicates a change with time in square of the absorbance indicated by the line “a”. As can be seen from the line “b”, it is revealed that in the coloring direction, there is a suitable linear relationship between the square of the absorbance and the drive time. This is because the EC element, in particular, the organic EC element, was rate-controlled by the diffusion of a material under the constant voltage as described above.

That is, in the accelerated drive in the coloring direction, by performing control so that the period of the accelerated drive satisfies a relationship of Formula (a), it is possible to control the transitional state in which the light transmittance changes, thereby suppressing an excessive absorbance change.

$${T}_{m} \leq {( \frac{Δ {Q}_{m}}{Δ {Q}_{n}} )}^{2} {T}_{n} \qquad ( a )$$

Further, the control of the period of the transitional state can also be achieved as follows. Specifically, based on (ΔQ)²/t, which is the slope of the line that is obtained by linearly approximating the relationship between the square of the absorbance change amount ΔQ and the time t of acceleration in the accelerated drive in the coloring direction, the drive time t₁ required to increase the absorbance from the current absorbance to the target absorbance is calculated. Then, the period t₀ of the accelerated drive is set so as to satisfy t_{A}≦t₁.

### Example 4

In Example 4, as the EC layer 7, a solution obtained by dissolving the compound 1 in a propylene carbonate solvent together with a supporting electrolyte (TBAP) was injected. The concentration of the compound 1 was 10 mM, and other element constructions were the same as in Example 1.

FIG. 12 is a graph for showing a relationship between the absorbance change and the drive time in the decoloring direction when, after the organic EC element was saturated in the coloring direction, the duty ratio was decreased in a stepwise manner under the state in which the drive voltage of 2.0 V was applied.

As shown in FIG. 12, the organic EC element changed its absorbance to be reached depending on the duty ratio, and even in the decoloring direction, the light transmittance was able to be controlled by the control of the duty ratio. Further, as the duty ratio became smaller, an amount and speed of change in absorbance became larger, and time spent for the transitional state became shorter.

From this result, by performing the accelerated drive at the duty ratio D4 smaller than the duty ratio D3 before the normal drive at the duty ratio D3 for maintaining the absorbance at the target absorbance, it is possible to enhance the operating performance in the decoloring direction.

### Example 5

In the investigation made by the inventors of the present invention, depending on a material to be used, the generated cations caused association in some cases. A material that causes association shows different behaviors of an absorption change between cations and cations in an associated form at the time of coloring and decoloring. As a result, the absorption spectrum greatly changes in some cases.

In the EC element 1 of Example 5, as the EC layer 7, a solution obtained by dissolving the compounds 1 and 2 in a propylene carbonate solvent together with a supporting electrolyte (TBAP) was injected. The concentrations of the compounds 1 and 2 were 13.5 mM and 30 mM, respectively, and other element constructions were the same as in Example 1. The compounds 1 and 2 were each an organic EC material in which an influence of association formation was not visually observed.

In an EC element 2 of Example 5, as the EC layer 7, a solution obtained by dissolving the compound 3 and the compound 4 in a propylene carbonate solvent together with a supporting electrolyte (TBAP) was injected. The concentrations of the compound 3 and the compound 4 were 7.5 mM and 10 mM, respectively, and other element constructions were the same as in Example 1. The compound was an organic EC material in which an influence of association formation was not visually observed, and the compound 4 was an organic EC material that causes association.

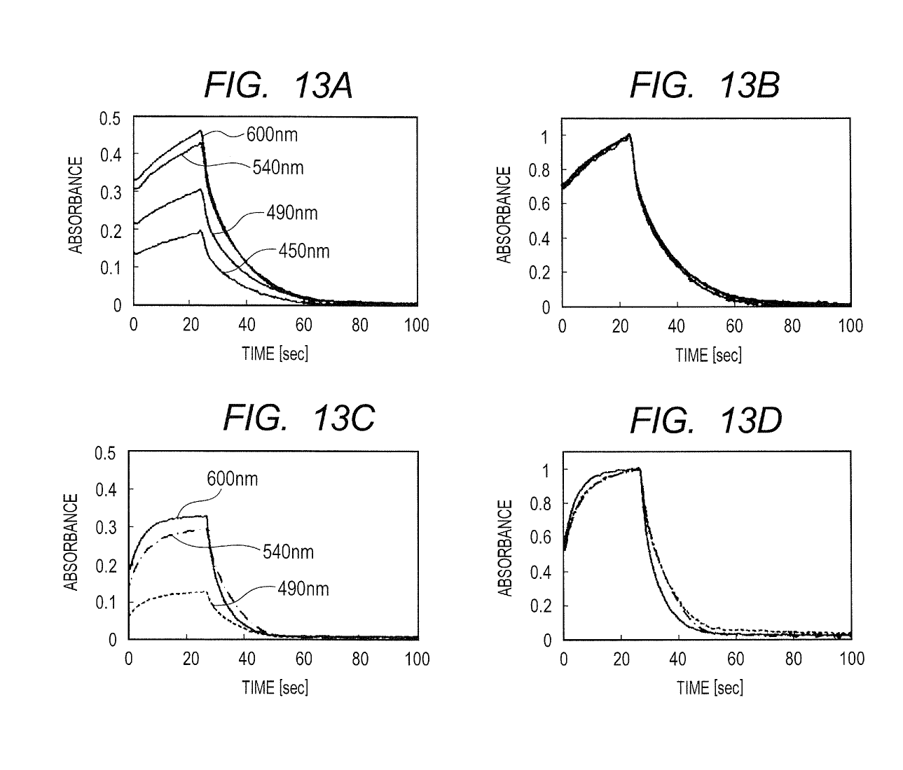

FIG. 13A and FIG. 13B are graphs each for showing a change with time in absorbance of the element 1 at the time of coloring and decoloring, and FIG. 13C and FIG. 13D are graphs each for showing a change with time in absorbance of the element 2 at the time of coloring and decoloring. A voltage of 2.3 V was applied between the electrodes for 25 seconds at the time of coloring, and a voltage of 0 V was applied therebetween for 60 seconds at the time of decoloring.

FIG. 13A is a graph for showing a change with time in absorbance at the time of coloring and decoloring at the absorption wavelengths of the compounds 1 and 2. Wavelengths of 540 nm and 600 nm correspond to absorption peaks of cation species of the compound 1, and wavelengths of 450 nm and 490 nm correspond to absorption peaks of cation species of the compound 2. In addition, FIG. 13B is a graph for showing a change with time in absorbance normalized with respect to a time point at which the absorbance is maximized (after about 25 seconds) for the respective wavelengths. It is revealed that the normalized absorbances of the respective materials at the respective wavelengths show relatively matching behavior at the time of coloring and decoloring.

FIG. 13C is a graph for showing a change with time in absorbance at the time of coloring and decoloring at the absorption wavelengths of the compounds 3 and 4. A wavelength of 540 nm is considered to correspond to an absorption peak of cation species of the compound 4, and a wavelength of 490 nm is considered to correspond to an absorption peak of cation species of the compound 4 causing association with each other. A wavelength of 600 nm corresponds to an absorption peak of cation species of the compound 3. In addition, FIG. 13D is a graph for showing a change with time in absorbance normalized with respect to a time point at which the absorbance is maximized (after about 25 seconds) for the respective wavelengths. It is revealed that the normalized absorbances of the respective materials at the respective wavelengths show different behaviors at the time of coloring and decoloring. In particular, distortion at the time of decoloring is large. The absorbance is distorted nearly doubly depending on time. It is considered that secondary behavior of generated cations causing association with each other has an influence.

As described above, in the organic EC element including a plurality of kinds of EC materials, the case where the EC materials are formed only of materials that do not cause association is preferred because the absorption spectra can be maintained in one or both of a coloring direction and a decoloring direction.

In the organic EC element formed of a material that does not cause association, by performing the accelerated drive at the duty ratio D2 larger than the duty ratio D1 before the normal drive at the duty ratio D1 for maintaining the target absorbance, it is possible to enhance the operating performance in the coloring direction. Further, by performing the accelerated drive at the duty ratio D4 smaller than the duty ratio D3 before the normal drive at the duty ratio D3 for maintaining the target absorbance, it is possible to enhance the operating performance in the decoloring direction.

### Example 6

In Example 6, as anodic EC materials, metallocene derivatives; aromatic amine derivatives such as phenazine derivatives, triphenylamine derivatives, phenothiazine derivatives, phenoxazine derivatives; pyrrole derivatives; pyrazoline derivatives other than thiophene derivatives were used.

Single material or plural materials between the same derivatives or plural materials between the different derivatives were used for the organic EC element.

By performing the accelerated drive at the duty ratio D2 larger than the duty ratio D1 before the normal drive at the duty ratio D1 for causing the absorbance to reach the target absorbance and maintaining the target absorbance, it was possible to enhance the operating performance in the coloring direction.

And by performing the accelerated drive at the duty ratio D4 smaller than the duty ratio D3 before the normal drive at the duty ratio D3 for maintaining the absorbance at the target absorbance, it was possible to enhance the operating performance in the decoloring direction.

### Example 7

In Example 7, as cathodic EC materials, anthraquinone-based compounds; ferrocenium salt-based compounds; styryl-based compounds other than viologen-based compounds were used.

Single material or plural materials between the same derivatives or plural materials between the different derivatives were used for the organic EC element.

By performing the accelerated drive at the duty ratio D2 larger than the duty ratio D1 before the normal drive at the duty ratio D1 for causing the absorbance to reach the target absorbance and maintaining the target absorbance, it was possible to enhance the operating performance in the coloring direction.

And by performing the accelerated drive at the duty ratio D4 smaller than the duty ratio D3 before the normal drive at the duty ratio D3 for maintaining the absorbance at the target absorbance, it was possible to enhance the operating performance in the decoloring direction.

### Example 8

In Example 8, as anodic EC materials, thiophene derivatives; metallocene derivatives; aromatic amine derivatives such as phenazine derivatives, triphenylamine derivatives, phenothiazine derivatives, phenoxazine derivatives; pyrrole derivatives; pyrazoline derivatives were used.

And as cathodic EC materials, anthraquinone-based compounds; ferrocenium salt-based compounds; styryl-based compounds other than viologen-based compounds were used.

The combinations between one anodic material and one cathodic material or plural anodic materials and one cathodic material or one anodic material and plural cathodic materials or plural anodic materials and plural cathodic materials were used for the organic EC element.

By performing the accelerated drive at the duty ratio D2 larger than the duty ratio D1 before the normal drive at the duty ratio D1 for causing the absorbance to reach the target absorbance and maintaining the target absorbance, it was possible to enhance the operating performance in the coloring direction.

And by performing the accelerated drive at the duty ratio D4 smaller than the duty ratio D3 before the normal drive at the duty ratio D3 for maintaining the absorbance at the target absorbance, it was possible to enhance the operating performance in the decoloring direction.

According to the one embodiment of the present invention, it is possible to provide the EC apparatus having an excellent operating performance, which is capable of controlling, during the transitional state in which the light transmittance of the EC element changes, the speed and period of the transitional state in which the light transmittance changes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-159412, filed Aug. 5, 2014, which is hereby incorporated by reference herein in its entirety.

What is claimed is:

1. An apparatus for driving an electrochromic element, the apparatus being configured to apply a continuous drive pulse to an electrochromic element, the electrochromic element including an electrochromic layer that contains an electrochromic material and is sandwiched between a pair of electrodes, and to change an absorbance of the electrochromic element with use of a duty ratio of the continuous drive pulse,
the continuous drive pulse having one cycle including an applied period of a drive voltage and a stopped period of the drive voltage,
the drive voltage comprising a voltage for causing at least one of an oxidation reaction of the electrochromic material and a reduction reaction of the electrochromic material,
the stopped period comprising a period in which, in a closed circuit including the electrochromic element, a resistor having a resistance value larger than a resistance value of another resistor to be connected during the applied period is connected in series,
the duty ratio comprising a ratio of the applied period of the drive voltage to the one cycle,
the apparatus being configured to perform, when the absorbance of the electrochromic element is to be increased from a current absorbance to a target absorbance, before normal drive of driving the electrochromic element at a duty ratio D1 for maintaining the target absorbance, accelerated drive of driving the electrochromic element at a duty ratio D2 larger than the duty ratio D1.

2. The apparatus for driving an electrochromic element according to claim 1, wherein the drive voltage comprises a constant voltage.

3. The apparatus for driving an electrochromic element according to claim 1, wherein when arbitrary two absorbance change amounts of the electrochromic element are represented by ΔQₘ and ΔQₙ, and when periods of the accelerated drive that are required for the arbitrary two absorbance change amounts ΔQₘ and ΔQₙ are represented by Tₘ and Tₙ, respectively, the periods of the accelerated drive are set so as to satisfy a relationship of Formula (a):
$${T}_{m} \leq {( \frac{Δ {Q}_{m}}{Δ {Q}_{n}} )}^{2} {T}_{n} . \qquad ( a )$$

4. The apparatus for driving an electrochromic element according to claim 1, wherein (ΔQ)²/t, which is a slope of a line obtained by linearly approximating a relationship between a time t and a square of a change amount (ΔQ) of the absorbance at a time of the accelerated drive, is acquired in advance, when the absorbance of the electrochromic element is to be increased from the current absorbance to the target absorbance, a time t₁ corresponding to a change amount of the absorbance is calculated based on the slope, and a period t₀ of the accelerated drive is set so as to satisfy t_{A}≦t₁.

5. The apparatus for driving an electrochromic element according to claim 1, wherein the duty ratio D2 is 100%.

6. The apparatus for driving an electrochromic element according to claim 1, further configured to perform, when the absorbance of the electrochromic element is to be decreased from a current absorbance to a target absorbance, before normal drive of driving the electrochromic element at a duty ratio D3 for maintaining the target absorbance, accelerated drive of driving the electrochromic element at a duty ratio D4 smaller than the duty ratio D3.

7. The apparatus for driving an electrochromic element according to claim 6, wherein the duty ratio D4 is 0%.

8. The apparatus for driving an electrochromic element according to claim 1, wherein the electrochromic material comprises a composition in which a plurality of compounds each represented by the following general formula [1] are mixed: 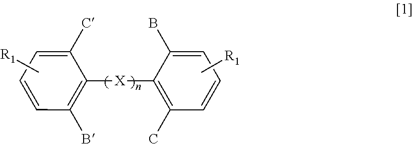
where:
B, B′, C, and C′ are each independently selected from an alkyl group having 1 or more to 20 or less carbon atoms, an alkoxy group having 1 or more to 20 or less carbon atoms, and an aryl group that may have a substituent;
R₁ represents a hydrogen atom or a substituent;
n represents an integer of from 1 to 5; and
X represents a structure represented by the following general formula [2] or [3], and when n represents an integer of 2 or more, X's are each independently selected from the structures represented by the following general formulae [2] and [3]: 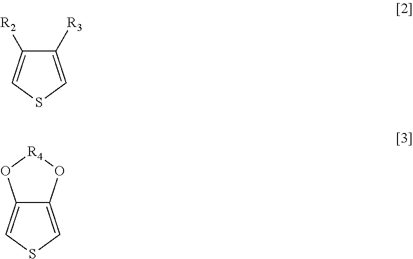
where:
R₂ and R₃ are each independently selected from a hydrogen atom, an alkyl group having 1 or more to 20 or less carbon atoms, an alkoxy group having 1 or more to 20 or less carbon atoms, an aryl group that may have a substituent, and an alkyl ester group having 1 or more to 20 or less carbon atoms;
R₄ represents an alkylene group having 1 or more to 20 or less carbon atoms; and
when a thiophene ring adjacent to an aromatic ring having the groups B, B′, C, and C′ in the general formula [1] is represented by the general formula [2], R₂ and R₃ each represent a substituent other than a hydrogen atom.

9. An optical filter, comprising:
an electrochromic element; and
the apparatus for driving an electrochromic element according to claim 1.

10. An image pickup apparatus, comprising:
the optical filter according to claim 9; and
a light receiving element configured to receive light that has been transmitted through the optical filter.

11. A lens unit, comprising:
the optical filter according to claim 9; and
an optical system comprising a plurality of lenses.

12. A window member, comprising:
an electrochromic element; and
the apparatus for driving an electrochromic element according to claim 1.

13. A method of driving an electrochromic element, for applying a continuous drive pulse to an electrochromic element, the electrochromic element including an electrochromic layer that contains an electrochromic material and is sandwiched between a pair of electrodes, and changing an absorbance of the electrochromic element with use of a duty ratio of the continuous drive pulse,
the continuous drive pulse having one cycle including an applied period of a drive voltage and a stopped period of the drive voltage,
the drive voltage comprising a voltage for causing at least one of an oxidation reaction of the electrochromic material and a reduction reaction of the electrochromic material,
the stopped period comprising a period in which, in a closed circuit including the electrochromic element, a resistor having a resistance value larger than a resistance value of another resistor to be connected during the applied period is connected in series,
the duty ratio comprising a ratio of the applied period of the drive voltage to the one cycle,
the method comprising performing, when the absorbance of the electrochromic element is to be increased from a current absorbance to a target absorbance, before normal drive of driving the electrochromic element at a duty ratio D1 for maintaining the target absorbance, accelerated drive of driving the electrochromic element at a duty ratio D2 larger than the duty ratio D1.

14. The method of driving an electrochromic element according to claim 13, wherein the drive voltage comprises a constant voltage.

15. A method of driving an electrochromic element according to claim 13, further comprising setting, when arbitrary two absorbance change amounts of the electrochromic element are represented by ΔQₘ and ΔQₙ, and when periods of the accelerated drive that are required for the arbitrary two absorbance change amounts ΔQₘ and ΔQₙ are represented by Tₘ and Tₙ, respectively, the periods of the accelerated drive so as to satisfy a relationship of Formula (a):
$${T}_{m} \leq {( \frac{Δ {Q}_{m}}{Δ {Q}_{n}} )}^{2} {T}_{n} . \qquad ( a )$$

16. The method of driving an electrochromic element according to claim 13, further comprising:
acquiring in advance, (ΔQ)²/t, which is a slope of a line obtained by linearly approximating a relationship between a time t and a square of a change amount (ΔQ) of the absorbance at a time of the accelerated drive;
calculating, when the absorbance of the electrochromic element is to be increased from the current absorbance to the target absorbance, a time t₁ corresponding to a change amount of the absorbance based on the slope; and
setting a period t₀ of the accelerated drive so as to satisfy t_{A}≦t₁.

17. The method of driving an electrochromic element according to claim 13, wherein the duty ratio D2 is 100%.

18. The method of driving an electrochromic element according to claim 13, further comprising performing, when the absorbance of the electrochromic element is to be decreased from a current absorbance to a target absorbance, before normal drive of driving the electrochromic element at a duty ratio D3 for maintaining the target absorbance, accelerated drive of driving the electrochromic element at a duty ratio D4 smaller than the duty ratio D3.

19. The method of driving an electrochromic element according to claim 18, wherein the duty ratio D4 is 0%.

20. The method of driving an electrochromic element according to claim 13, wherein the electrochromic material comprises a composition in which a plurality of compounds each represented by the following general formula [1] are mixed: 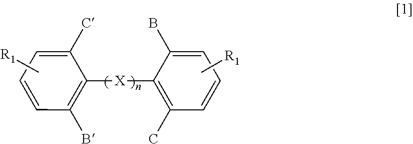
where:
B, B′, C, and C′ are each independently selected from an alkyl group having 1 or more to 20 or less carbon atoms, an alkoxy group having 1 or more to 20 or less carbon atoms, and an aryl group that may have a substituent;
R₁ represents a hydrogen atom or a substituent;
n represents an integer of from 1 to 5; and
X represents a structure represented by the following general formula [2] or [3], and when n represents an integer of 2 or more, X's are each independently selected from the structures represented by the following general formulae [2] and [3]: 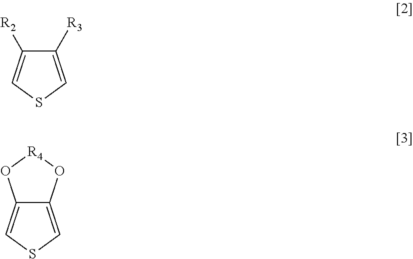
where:
R₂ and R₃ are each independently selected from a hydrogen atom, an alkyl group having 1 or more to 20 or less carbon atoms, an alkoxy group having 1 or more to 20 or less carbon atoms, an aryl group that may have a substituent, and an alkyl ester group having 1 or more to 20 or less carbon atoms;
R₄ represents an alkylene group having 1 or more to 20 or less carbon atoms; and
when a thiophene ring adjacent to an aromatic ring having the groups B, B′, C, and C′ in the general formula [1] is represented by the general formula [2], R₂ and R₃ each represent a substituent other than a hydrogen atom.
